(19) United States
(12) Patent Application Publication
(10) Pub. No.: US 2019/0109886 A1
(43) Pub. Date: Apr. 11, 2019

(54) SELECTED DATA EXCHANGE

(71) Applicant: Panasonic Automotive Systems Company of America, Division of Panasonic Corporation of North America, PEACHTREE CITY, GA (US)

(72) Inventors: PRAVEEN URS MYSORE KRISHNA, PEACHTREE CITY, GA (US); SUDHEER HEGDE, PEACHTREE CITY, GA (US); KARTHIK NAGARAJ, PEACHTREE CITY, GA (US)

(73) Assignee: Panasonic Automotive Systems Company of America, Division of Panasonic Corporation of North America

(21) Appl. No.: 16/137,632

(22) Filed: Sep. 21, 2018

Related U.S. Application Data
(60) Provisional application No. 62/570,376, filed on Oct. 10, 2017.

(51) Int. Cl. H04L 29/08; G07C 5/00; H04W 4/40

(52) U.S. Cl. CPC H04L 67/06; H04W 4/40; H04L 67/12; G07C 5/008

(57) ABSTRACT

Examples of the present disclosure relate to a device, method, and system for selected data exchange. For example, a vehicle head unit device for selected data exchange may include a processor to generate a list of vehicle files available to be transmitted, where the list of vehicle files includes file-identifying information for each vehicle file available to be sent from the vehicle head unit device. In an example, the vehicle head unit device includes a transmitter to send the list of vehicle files to a server. In an example, the processor of the vehicle head unit device is to generate a file package in response to receiving a request from the server, where the request indicates a selected subset of the vehicle files in the list of vehicle files based on the file-identifying information in the list of vehicle files sent to the server, and where the file package comprises the selected subset of the vehicle files identified by the request. The vehicle head unit device may then use the transmitter to send the file package to the server.

### CROSS-REFERENCE TO RELATED APPLICATIONS

This application claims the benefit of U.S. Provisional Application No. 62/570,376, filed on Oct. 10, 2017, which the disclosure of which is hereby incorporated by reference in its entirety for all purposes.

### FIELD OF THE INVENTION

The present disclosure generally relates to a method, system, and device for selected data exchange. More specifically, the present disclosure relates to selected data exchange between a vehicle head unit device such and server device located remotely from the automobile.

### BACKGROUND

This section is intended to introduce the reader to various aspects of art, which may be related to various aspects of the present disclosure, which are described and/or claimed below. This discussion is believed to be helpful in providing the reader with background information to facilitate a better understanding of the various aspects of the present disclosure. Accordingly, it can be understood that these statements are to be read in this light, and not as admissions of prior art.

Vehicles, such as automobiles may utilize a connection with a server in order to transport data and files between one another. The units for communication in an automobile may be a vehicle head unit device which can be a combination of components commonly mounted under the dashboard of the automobile. While this disclosure refers to vehicle head unit devices, other computing devices may also be contemplated including those integrated into mobile devices, automobiles, transportation vehicles, tablets, and other mobile computing form factors. Servers may provide processing, storage, networking, and other capabilities sometimes logically and physically separate from the client devices. Client devices may store files, gather log files, run self-diagnostics, and execute client applications, among other functions.

### SUMMARY

This specification generally discloses a vehicle head unit device for selected data exchange, including a processor to generate a list of vehicle files available to be transmitted, where the list of vehicle files includes file-identifying infbrmation for each vehicle file available to be sent from the vehicle head unit device. The vehicle head unit device can also include a transmitter to send the list of vehicle files to a server. The processor of the vehicle head unit device may also generate a file package in response to receiving a request from the server, where the request indicates a selected subset of the vehicle files in the list of vehicle files based on the file-identifying information in the list of vehicle files sent to the server, and where the file package includes the selected subset of the vehicle files identified by the request. Further, the vehicle head unit device can include the transmitter to send the file package to the server.

This specification generally discloses a method for selected data exchange, including generating a list of vehicle files in a vehicle head unit device including a list of vehicle files available to be transmitted, where the list of vehicle files includes file-identifying information for each vehicle file available to be sent from the vehicle head unit device. The method can also include transmitting the list of vehicle files to a server. The method can also include generating a file package in response to receiving a request from the server, where the request indicates a selected subset of the vehicle files in the list of vehicle files based on the file-identifying information in the list of vehicle files sent to the server, and where the file package includes the selected subset of the vehicle files identified by the request. The method can also include transmitting the file package to the server.

This specification generally discloses a system for selected data exchange including a vehicle head unit device to generate a list of vehicle files in a vehicle head unit device including a list of vehicle files available to be transmitted, where the list of vehicle files includes file-identifying information for each vehicle file available to be sent from the vehicle head unit device. The vehicle head unit device may also transmit the list of vehicle files to a server. The vehicle head unit device may also generate a file package in response to a request from the server, where the request indicates a selected subset of the vehicle files in the list of vehicle files based on the file-identifying information in the list of vehicle files sent to the server, where the file package includes the selected subset of the vehicle files identified by the request. The vehicle head unit device may also transmit the file package to the server. The system disclosed can include a server to select the subset of the vehicle files in the list of vehicle files in response to receiving the list of vehicle files. The server may also transmit the request from the server indicating the selected subset of the vehicle files. The server can also identify issues in the vehicle head unit device from analysis of the file package. The server may also transmit an identification of the server identified issues in the vehicle head unit device to the vehicle head unit device.

### BRIEF DESCRIPTION OF THE DRAWINGS

The above-mentioned and other features and advantages of the present disclosure, and the manner of attaining them, may become apparent and be better understood by reference to the following description of one example of the disclosure in conjunction with the accompanying drawings, wherein:

FIG. 1 is a drawing of an example selected data exchange system;

FIG. 2 is a drawing of an example list of vehicle files;

FIG. 3 is a schematic of an example repeating selected data exchange system;

FIG. 4 is a schematic of an example process of selected data exchange between the vehicle head unit device and the server;

FIG. 5 is a process flow diagram of an example method for selected data exchange; and

FIG. 6 is a drawing of an example computer-readable medium storing instructions, that when executed on a processor exchanges selected data.

Correlating reference characters indicate correlating parts throughout the several views. The exemplifications set out herein illustrate examples of the disclosure, in one form, and such exemplifications are not to be construed as limiting in any manner the scope of the disclosure.

### DETAILED DESCRIPTION OF EXAMPLES

One or more specific examples of the present disclosure are described below. In an effort to provide a concise description of these examples, not all features of an actual implementation are described in the specification. It can be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it can be appreciated that such a development effort might be complex and time consuming, and is a routine undertaking of design, fabrication, and manufacture for those of ordinary skill having the benefit of this disclosure.

The present disclosure describes a selected data exchange between a vehicle head unit device and a server. As discussed above, the vehicle head unit device may be a computing device including a mobile device, a tablet, laptop, or integrated in an automobile or other transit vehicle. In an example, a vehicle head unit device can be an infotainment system in a vehicle. In an automotive context, a computer system and display used as an infotainment system may be referred to as a head unit. Data transfer from a vehicle head unit device to a server can be a unidirectional exchange and a bi-directional exchange. As used herein, a server is a computer program or a device that provides functionality for other programs or devices, such as vehicle head unit devices. In an example, the server may be a cloud server or third party server, and may be located physically distant and separate from the vehicle head unit device while connected through a communications network. In order to distribute the computations of an application or service, a client may wish to transfer data and files to the server to redistribute or perform services with that data or files. While a vehicle head unit device may process files and perform services itself, by transferring tasks, data, and requests to a server, the vehicle head unit device may improve its functioning by reducing the load on its resources and thereby increasing its availability for other tasks. A vehicle head unit device's use of a server for distributing processing, storage, requests, and other services requires the transfer of data to the server. Data transfer itself can be a resource intensive process as data transfer can consume power and processing time. As mobile devices such as phones, tablets, and automobiles may have less space for components, the potential strain of data transfer may be even more pronounced. Accordingly, the present specification discloses a smart transfer of the data from a vehicle head unit device, such as a head units in an automobile, to a server, such as a cloud server. This smart transfer is a selected data exchange that allows data to be analyzed remotely from the vehicle head unit device at a server, minimizes data transfer, and allows analysis by the server regarding issues found in client data to be returned by the server to the vehicle head unit device with preventative or corrective actions.

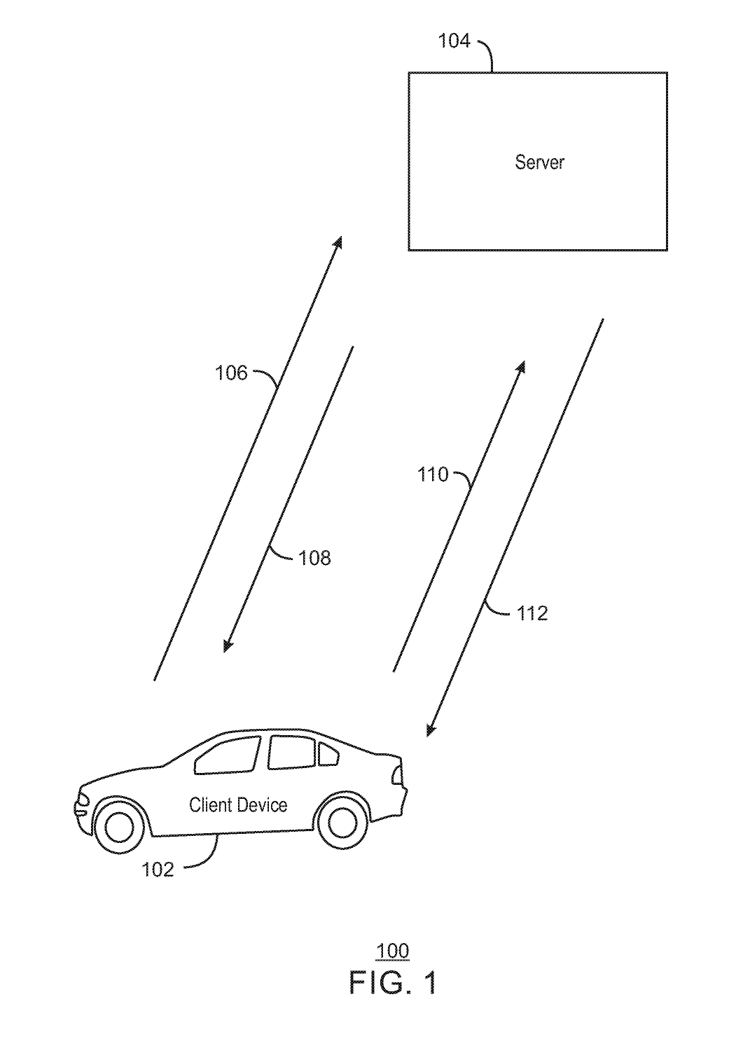

FIG. 1 is a drawing of an example selected data exchange system 100. Directional arrows located in this figure and other figures indicate a general flow of information but are not intended to be limiting with regards to which component may be performing an action such as a push or a pull of information from another component unless otherwise specified.

The example selected data exchange system 100 provides a general illustration of the way the client device 102 such as a vehicle head unit device and the server 104 may interact. The client device 102 may be operating normally, powering on, powering down, processing an application, recording action logs of itself, performing self-diagnostics of a core system and of subsystems, as well as other tasks. The client device 102 may have resources such as memory, storage, processing, power, software functionality, or hardware functionality. Accordingly, the client device 102 may wish to transfer some tasks to a server 104 to perform. Similarly, the client device 102 may wish to transfer data to a server 104 to store or analyze. The server 104 may store logic that when executed manages a client device 102 by instructing corrective and preventative actions at the client device 102 based on an analysis of files sent to the server 104 by the client device 102.

The client device 102 may identify data that the client device 102 may be sending to the server 104. These files may be diagnostics, logs, media files, sensor readouts, and the like. Depending on the files to be sent to the server 104, the client may record actions at the client device 102 to generate a log file or the client device 102 may instruct a dump of core files of the client device 102 such that they may be sent to the server 104 for resource intensive analysis that may have reduced the function of the client device 102 if performed on the client device 102. Once gathered, the client device 102 may generate a list of vehicle files that lists each of the files to possibly be sent as well as file-identifying information about each file like a file name, a time of creation, or a subsystem of the client device 102 to which the file is related. The list of vehicle files, once generated can be sent to the server 104 in a list of vehicle files transfer 106. The list of vehicle files transfer 106 includes sending file-identifying information through the list of vehicle files but avoids transferring files themselves to the server 104 at this time. In an example, the actual recording or generating of the files in the client device may occur before, during, or after the time of generating the list of vehicle files. When files are generated prior to the creation of a list of vehicle files, then the creation of the list of vehicle files may include parsing the previously generated files for information and obtaining a name from each file gathered. When files are generated after the generation of the list of vehicle files, these files may also be awaiting an instruction from the server 104 to be created and these files may be included in the list of vehicle files based on a client device 102 sending names of files that can be generated upon server 104 request.

In response to receiving the list of vehicle files in the list of vehicle files transfer 106, the server 104 may parse the list of vehicle files in order to select the files from the list of vehicle files that the server 104 will be requesting from the client device. The server 104 may select files in a number of ways based on the file-identifying information included in the list of vehicle files. In an example, the server 104 may select files from the list of vehicle files based on specific file name, based on a type of file, based on whether the file is a diagnostic file, based on whether the file is a log file, based on a time the file was created or last modified, among other criteria that may make use of the file-identifying information. Upon selecting the files the sever 104 would like to be sent from the client device 102, the server 104 sends a selected file request 108 to the client device 102. The selected file request 108 includes a listing of the selected files, which may be a subset of the files listed in the list of vehicle files.

Upon receiving the selected file request 108, the client device 102 may transfer the files indicated in the selected file request to the server 104 in a selected data transfer 110. This selected data transfer 110 limits a data transfer operation of the client device 102 to the selected files. As the files transferred to the server 104 may be a subset of the files available to transfer to the server 104, the file transfer operation of the client device 102 may be made more efficient by not expending resources sending files unrequested by the server 104.

In response to receiving the selected files, the server 104 may analyze, store, or perform other services with the selected files received from the client device 102. In the case of analysis or service that results in additional files being referenced, the server 104 may perform an additional selected file request 108 and receive the additional files. Upon the server 104 completing analysis or other services on the received selected files, the server 104 may have identified actions to be taken on the client device 102. Accordingly, the server 104 may transmit instructions in an instruction transmission 112 to the client device 112. The instruction transmission 112 may include a request to remove a file, add a file, or modify a file on the client device 102. The instruction transmission 112 may include a corrective or preventative action based on the analysis at the server 104 of the received selected files. Upon receipt of the instruction transmission 112, the client device 102 may perform the instruction which may affect the files listed in the list of vehicle files, the selected files, or other files in the control of the client device 102.

In an example, the client device 102 is an infotainment system that may share the list of vehicle files with a server 104 such as a cloud server. The server 104 decides and requests that the client system 102 shares desired data. In an example, the server 104 may request data based on the specific preventive actions to be taken on the client device 102, such as a vehicle. In an example, the server 104 may request data based on the specific corrective actions to be taken on the client device 102 such as a vehicle. By allowing a quicker, more efficient data transfer, the server 104 may take on additional diagnostic features for a vehicle and thereby reduce the frequency of maintenance trips at an automobile dealer. In an example, a client device 102 may be configured to send periodic reports either preventatively or to correspond to a detected issue uncovered by analysis by the server 104.

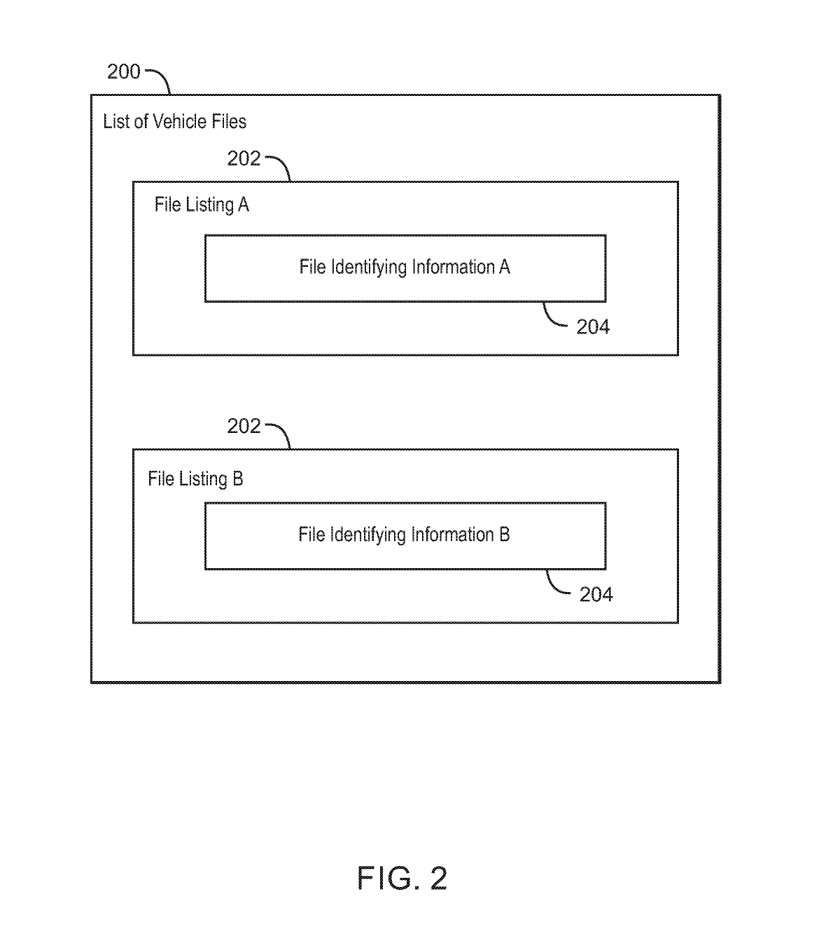

FIG. 2 is a drawing of an example list of vehicle files 200. The list of vehicle files 200 may be transferred in a list of vehicle files transfer 106 as discussed above. Further, the list of vehicle files 200 can be a list that lists each of the files in a client device to possibly be sent to a server. The items that may be included in a list of vehicle files 200 include file listing A and B 202 where each listing describes a separate file. Further each file listing A and B 202 includes their own file-identifying information A and B 204. File-identifying information can be a file name, a time of creation, an identification of a subsystem of the client device where the file was generated, an identification of a subsystem of the client device to which the file relates, a keyword describing the contents of the file, an author or authoring device or authoring program. In an example, the subsystem of a client device may include a memory, processor, graphics card, networking interface, display interface, sensor or sensor interface, and other types of client device subsystems whether hardware or software.

As described above, the server 104 may parse the list of vehicle files 200 to select files to request form the client device 102. The selection logic of the server may follow many different objectives, such as selecting any files that are related to diagnosis of potential issues on the client device. In an example, a client device may select files based on a file listing A or B 202 based on the file identifying information A or B 204 indicating which file has a keyword of “log” as file-identifying information A or B 204.

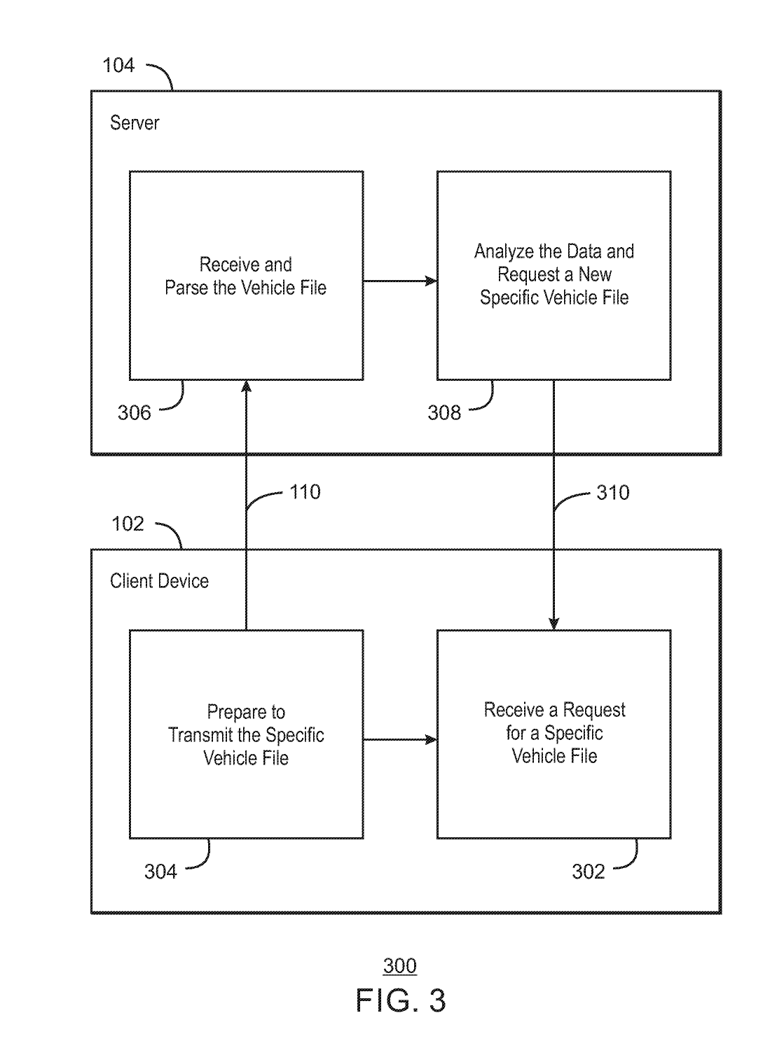

FIG. 3 is a schematic of an example repeating selected data exchange system 300. Like numbered items are as described with respect to FIG. 1.

The repeating selected data exchange system 300 generally illustrates a possible action in in the selected data exchange process. Specifically, if a client device 102 receives a request for a specific vehicle file 302 from a server 104, then the client device 102 may prepare to transmit the specific vehicle file 304 to the server 104 as a selected data transfer 110. The server 104 may receive and parse the vehicle file 306. Once parsed, the parsed vehicle file 306 can be analyzed and then based on the analysis, a newly referenced or complimentary vehicle file may be requested 308. This new vehicle file request 310 may be made to the client device 302 and the process starts again. The iterative nature of this process ensures an efficient data transfer of specific vehicle files when these vehicle files are analyzed and processed but not before they may be requested. The iterative process also ensures that all necessary specific vehicle files are retrieved from a client device for a complete analysis by the server 104.

In an example, this iterative process may reduce the amount of data that the client device 102, such as a vehicle, has to send to a server 104. In an example, this iterative process allows for more effective data collection from the client device 102 because the data to be gathered in the client device 102 is determined remotely on the server 104 based on a previous data set sent by the client device 102. In an example, this iterative process ensures that rules on the server 104 enable customization of the next data set requested based on the previous data set, in an example, this iterative process allows the rules of a remote server service to be changed and modified dynamically without having to update the client device 102 software.

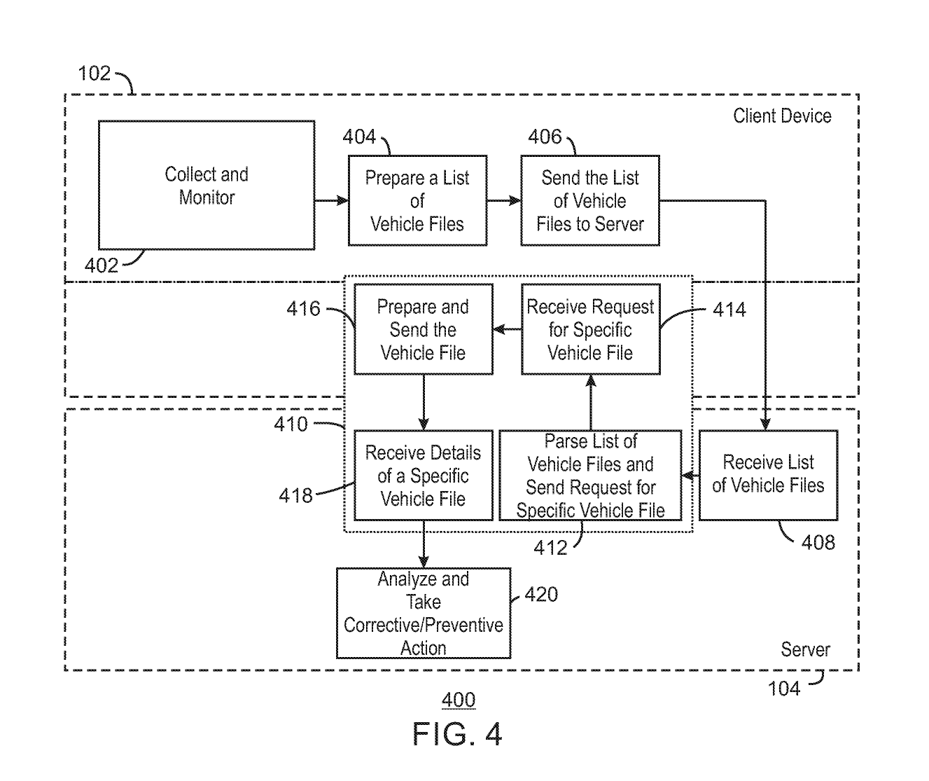

FIG. 4 is a schematic of an example process 400 of selected data exchange between the client device and the server. Like numbered items are as described with respect to FIG. 1.

At block 402, the client device may collect and monitor analytics data. As the client device 102 may be a vehicle head unit device, the client device may monitor and collect data such as log data, core dump files, and other data. At block 404, the client device 202 may prepare a list of vehicle files. In block 406, the head unit may send the list of vehicles to the server 104 via an available transport medium. In an example, the transport medium may be Bluetooth, and mobile base station, among others.

At block 408, the server 104 can receive the list of vehicles at which point the list may be sent into the iterative process 410 similar to that described in FIG. 3. At block 412, the server 104 may parse the file and send a request for specific data to the client device 102. The server 104 parses the list of vehicles and then may request the client device 102 send details a more full data files for a number of file names the server wishes to view or manipulate.

At block 414, the client device 102 may receive the request for the specific vehicle file. At block 416, the client device may prepare and send the specific vehicle file requested back to the server 104. At block 418, the server 104 may receive details of a specific vehicle file. Further at block 418, the server 402 may decide that additional vehicle files are needed as shown in FIG. 3, and if so the process flow would proceed again to block 412. However, in FIG. 4, the server 104 has determined that the specific vehicle file retrieved allows the process to proceed to block 420. At block 420, the server 104 analyzes the specific data and determines any corrective or preventative action that the server 104 sends back to the client device 104.

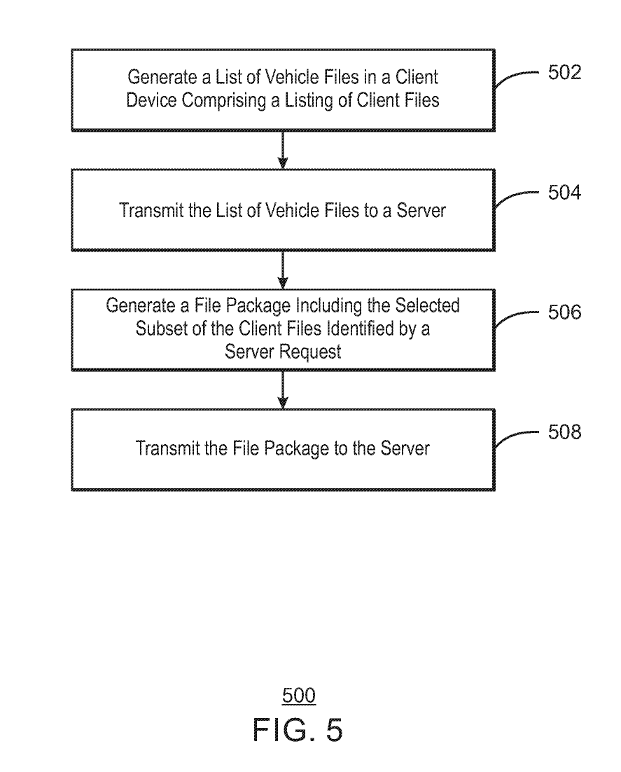

FIG. 5 is a process flow diagram of an example method 500 for selected data exchange. At block 502, the method 500 generates a list of vehicle files in a client device including a list of vehicle files available to be transmitted, where the list of vehicle files includes file-identifying information for each vehicle file available to be sent from the client device. In an example, the identifying information is a timestamp associated with each vehicle file available to be sent from the client device. The identifying information of a specific vehicle file may specify a subsystem of the client device that is involved in generating the specific vehicle file.

At block 504, the method 500 transmits the list of vehicle files to a server. At block 506, the method 500 generates a file package in response to receiving a request from the server, where the request indicates a selected subset of the vehicle files in the list of vehicle files based on the file-identifying information in the list of vehicle files sent to the server, and where the file package includes the selected subset of the vehicle files identified by the request. At block 508, the method 500 transmits the file package to the server.

The method may also include modifying a vehicle file in the selected subset of the vehicle files in response to a received instruction from the server after transmitting the file package to the server. The method may include removing a vehicle file in the selected subset of the vehicle files in response to a received instruction from the server after transmitting the file package to the server. The method may include adding a vehicle file in response to a received instruction from the server after transmitting the file package to the server. In some cases, the method may address a server identified issue in the vehicle head unit device in response to a received instruction from the server after transmitting the file package to the server. In an example, the vehicle files are one or more of log files or core dump files.

As far as timing of actions, the method may collect the data of the vehicle files prior to generating the list of vehicle files. The method may collect the data of the vehicle files after generating the list of vehicle files. In an example, the method may collect the data of the vehicle files in response to receiving the request from the server that indicates the selected subset of the vehicle files in the list of vehicle files.

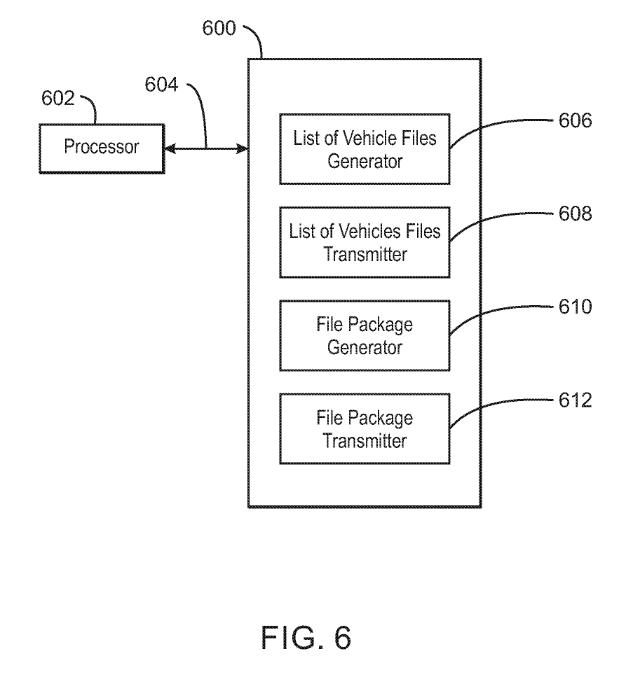

FIG. 6 is a drawing of an example computer-readable medium 600 storing instructions, that when executed on a processor exchanges selected data. The tangible, non-transitory, computer-readable medium 600 includes instructions that, when executed by a processor 602 can direct the processor 602 through a bus 604 to test state machine software.

The computer-readable medium 600 includes a list of vehicle files generator 606 to generate a list of vehicle files in a client device including a list of vehicle files available to be transmitted, where the list of vehicle files includes file-identifying information for each vehicle file available to be sent from the client device. In an example, the identifying information is a timestamp associated with each vehicle file available to be sent from the client device. The identifying information of a specific vehicle file may specify a subsystem of the client device that is involved in generating the specific vehicle file.

The computer-readable medium 600 includes a list of vehicle files transmitter 608 to transmit the list of vehicle files to a server. The computer-readable medium 600 includes a file package generator 610 to generate a file package in response to receiving a request from the server, where the request indicates a selected subset of the vehicle files in the list of vehicle files based on the file-identifying information in the list of vehicle files sent to the server, and where the file package includes the selected subset of the vehicle files identified by the request. The computer-readable medium 600 includes a file package transmitter 612 to transmit the file package to the server.

The computer-readable medium 600 may also include instructions that when executed by a processor modify a vehicle file in the selected subset of the vehicle files in response to a received instruction from the server after transmitting the file package to the server. The computer-readable medium 600 may include instructions that when executed by a processor remove a vehicle file in the selected subset of the vehicle files in response to a received instruction from the server after transmitting the file package to the server. The computer-readable medium 600 may include instructions that when executed by a processor add a vehicle file in response to a received instruction from the server after transmitting the file package to the server. In some cases, the computer-readable medium 600 may include instructions that when executed by a processor address a server identified issue in the client device in response to a received instruction from the server after transmitting the file package to the server. In an example, the vehicle files are one or more of log files or core dump files. As used herein, core dump files include the recorded state of the working memory of a computer program at a specific time, generally when the program has crashed or otherwise terminated abnormally. Core dump files may also include other information of the state of a program and are usually dumped at the same time, including the processor registers, which may include the program counter and stack pointer, memory management information, and other processor and operating system flags and information. Core dumps are often used to assist in diagnosing and debugging errors in computer programs.

As far as timing of actions, the computer-readable medium 600 may collect the data of the vehicle files prior to generating the list of vehicle files. The computer-readable medium 600 may collect the data of the vehicle files after generating the list of vehicle files. In an example, the computer-readable medium 600 may collect the data of the vehicle files in response to receiving the request from the server that indicates the selected subset of the vehicle files in the list of vehicle files.

What is claimed is:

1. A vehicle head unit device for selected data exchange, comprising:
a processor to generate a list of vehicle files available to be transmitted, wherein the list of vehicle files comprises file-identifying information for each vehicle file available to be sent from the vehicle head unit device;
a transmitter to send the list of vehicle files to a server;
the processor to generate a file package in response to receiving a request from the server, wherein the request indicates a selected subset of the vehicle files in the list of vehicle files based on the file-identifying information in the list of vehicle files sent to the server, and wherein the file package comprises the selected subset of the vehicle files identified by the request; and
the transmitter to send the file package to the server.

2. The vehicle head unit device of claim 1, wherein the processor is to collect the data of the vehicle files prior to generating the list of vehicle files.

3. The vehicle head unit device of claim 1, wherein the processor is to collect the data of the vehicle files after generating the list of vehicle files.

4. The vehicle head unit device of claim 1, wherein the processor is to collect the data of the vehicle files in response to receiving the request from the server that indicates the selected subset of the vehicle files in the list of vehicle files.

5. The vehicle head unit device of claim 1, wherein the identifying information is a timestamp associated with each vehicle file available to be sent from the vehicle head unit device.

6. The vehicle head unit device of claim 1, wherein the identifying information of a specific vehicle file specifies a subsystem of the vehicle head unit device that is involved in generating the specific vehicle file.

7. The vehicle head unit device of claim 1, wherein the processor is to modify a vehicle file in the selected subset of the vehicle files in response to a received instruction from the server after transmitting the file package to the server.

8. The vehicle head unit device of claim 1, wherein the processor is to remove a vehicle file in the selected subset of the vehicle files in response to a received instruction from the server after transmitting the file package to the server.

9. The vehicle head unit device of claim 1, wherein the processor is to add a vehicle file in response to a received instruction from the server after transmitting the file package to the server.

10. The vehicle head unit device of claim 1, wherein the processor is to address a server identified issue in the vehicle head unit device in response to a received instruction from the server after transmitting the file package to the server, and wherein the vehicle files are one or more of log files or core dump files.

11. A method for selected data exchange, comprising:
generating a list of vehicle files in a vehicle head unit device comprising a list of vehicle files available to be transmitted, wherein the list of vehicle files comprises file-identifying information for each vehicle file available to be sent from the vehicle head unit device;
transmitting the list of vehicle files to a server;
generating a file package in response to receiving a request from the server, wherein the request indicates a selected subset of the vehicle files in the list of vehicle files based on the file-identifying information in the list of vehicle files sent to the server, and wherein the file package comprises the selected subset of the vehicle files identified by the request; and
transmitting the file package to the server.

12. The method of claim 11, comprising collecting the data of the vehicle files prior to generating the list of vehicle files.

13. The method of claim 11, comprising collecting the data of the vehicle files after generating the list of vehicle files.

14. The method of claim 11, comprising collecting the data of the vehicle files in response to receiving the request from the server that indicates the selected subset of the vehicle files in the list of vehicle files.

15. The method of claim 11, wherein the identifying information is a timestamp associated with each vehicle file available to be sent from the vehicle head unit device.

16. The method of claim 11, wherein the identifying information of a specific vehicle file specifies a subsystem of the vehicle head unit device that is involved in generating the specific vehicle file.

17. The method of claim 11, comprising modifying a vehicle file in the selected subset of the vehicle files in response to a received instruction from the server after transmitting the file package to the server.

18. The method of claim 11, comprising removing a vehicle file in the selected subset of the vehicle files in response to a received instruction from the server after transmitting the file package to the server.

19. The method of claim 11, comprising adding a vehicle file in response to a received instruction from the server after transmitting the file package to the server.

20. The method of claim 11, comprising:
addressing a server identified issue in the vehicle head unit device in response to a received instruction from the server after transmitting the file package to the server; and
wherein the vehicle files are one or more of log files or core dump files.

21. A system for selected data exchange comprising:
a vehicle head unit device to:
generate a list of vehicle files in a vehicle head unit device comprising a list of vehicle files available to be transmitted, wherein the list of vehicle files comprises file-identifying information for each vehicle file available to be sent from the vehicle head unit device;
transmit the list of vehicle files to a server;
generate a file package in response to a request from the server, wherein the request indicates a selected subset of the vehicle files in the list of vehicle files based on the file-identifying information in the list of vehicle files sent to the server, and wherein the file package comprises the selected subset of the vehicle files identified by the request; and
transmit the file package to the server; and
the server to:
select the subset of the vehicle files in the list of vehicle files in response to receiving the list of vehicle files;
transmit the request from the server indicating the selected subset of the vehicle files;
identify issues in the vehicle head unit device from analysis of the file package; and
transmit an identification of server identified issues in the vehicle head unit device to the vehicle head unit device.

22. The system of claim 21, wherein the vehicle head unit device is to collect the data of the vehicle files prior to generating the list of vehicle files.

23. The system of claim 21, wherein the vehicle head unit device is to collect the data of the vehicle files after generating the list of vehicle files.

24. The system of claim 21, wherein the vehicle head unit device is to collect the data of the vehicle files in response to receiving the request from the server that indicates the selected subset of the vehicle files in the list of vehicle files.

25. The system of claim 21, wherein the identifying information is a timestamp associated with each vehicle file available to be sent from the vehicle head unit device.

26. The system of claim 21, wherein the identifying information of a specific vehicle file specifies a subsystem of the vehicle head unit device that is involved in generating the specific vehicle file.

27. The system of claim 21, wherein the vehicle head unit device is to modify a vehicle file in the selected subset of the vehicle files in response to a received instruction from the server after transmitting the file package to the server.

28. The system of claim 21, wherein the vehicle head unit device is to remove a vehicle file in the selected subset of the vehicle files in response to a received instruction from the server after transmitting the file package to the server.

29. The system of claim 21, wherein the vehicle head unit device is to add a vehicle file in response to a received instruction from the server after transmitting the file package to the server.

30. The system of claim 21, wherein the vehicle head unit device is to address a server identified issue in the vehicle head unit device in response to a received instruction from the server after transmitting the file package to the server, wherein the vehicle files are one or more of log files or core dump files.
